(19) United States
(12) Patent Application Publication
(10) Pub. No.: US 2013/0152465 A1
(43) Pub. Date: Jun. 20, 2013

(54) Methods for Rapidly Growing A Tree

(71) Applicant: Zhan-Wen Liao, Zhongli City (TW)

(72) Inventor: Zhan-Wen Liao, Zhongli City (TW)

(21) Appl. No.: 13/326,383

(22) Filed: Dec. 15, 2011

(51) Int. Cl. A01G 1/00; A01C 14/00

(52) U.S. Cl. 47/58.1 R; 111/100

(57) ABSTRACT

A method for rapidly growing a tree includes obtaining a cultivating material by cutting a length of a trunk or a bough from a tree. Twigs are removed from the cultivating material. A wound healing agent is applied on a severed end and on wounds of the cultivating material. A periphery of the lower section of the cultivating material is cut to form a plurality of grooves. The severed end is cut to obtain an oblique face. A root-growing agent is applied on the periphery of the lower section and the oblique face. The lower section of the cultivating material is planted into earth. A shield is wrapped around an intermediate section of the cultivating material. The cultivating material is cultivated for a plurality of months for growing roots from the lower section of the cultivating material and growing branches and leaves from a top section of the cultivating material.

### BACKGROUND OF THE INVENTION

The present invention relates to methods for rapidly growing a tree and, more particularly, to methods including cutting a length of a trunk or a bough of a tree and rapidly growing the length of the trunk or bough.

Larger trees on the roadside or in other locations or for decoration are generally moved from other places directly. Specifically, a worker digs a hole in the ground, plants a grown tree in the hole, and takes care of it.

People can have various feelings while cultivating plants. However, a man has to take care of a seedling for several years until it grows up into a tree having a suitable diameter. Considerable labor, time, and money are required.

Thus, a need exists for novel methods for rapidly growing a tree.

### BRIEF SUMMARY OF THE INVENTION

In an aspect of the present invention, a method for rapidly growing a tree includes obtaining a cultivating material by cutting a length of a trunk or a bough from a tree. The cultivating material includes a lower section having a severed end that was originally connected to the tree. Twigs are removed from the cultivating material. A wound healing agent is applied on the severed end and on wounds of the cultivating material resulting from removal of the twigs. A periphery of the lower section of the cultivating material is cut to form a plurality of grooves. The severed end is cut to obtain an oblique face. A root-growing agent is applied on the periphery of the lower section and the oblique face of the cultivating material. The lower section of the cultivating material obtained from the above steps is planted into earth. A shield is wrapped around an intermediate section of the cultivating material between the lower section and a top section of the cultivating material. The cultivating material is cultivated for a plurality of months for growing roots from the lower section of the cultivating material and growing branches and leaves from the top section of the cultivating material.

Preferably, the top section of the cultivating material has a length of 1-20 cm not wrapped by the shield.

The shield can be a plastic film or a plastic tape.

The shield is removed from the intermediate section of the cultivating material after the cultivating material grows the roots, the branches, and the leaves.

In an embodiment, planting the lower section of the cultivating material into the earth includes covering the lower section of the cultivating material by wet earth that has a thickness of a plurality of centimeters and that includes at least one root-growing material, wrapping the wet earth with a plastic tape or bag, removing the plastic tape after the wet earth is covered by the plastic tape or bag for one to eight months, and planting the lower section of the cultivating material with or without the wet earth into the earth.

In another aspect of the present invention, a method for rapidly growing a tree includes obtaining a plurality of cultivating materials. Each of the plurality of cultivating materials is obtained by cutting a length of a trunk or a bough from a tree. Each of the plurality of cultivating materials includes a lower section having a severed end that was originally connected to the tree. Twigs are removed from each of the plurality of cultivating materials. A wound healing agent is applied on the severed end and on wounds of each of the plurality of cultivating materials resulting from removal of the twigs. A periphery of the lower section of each of the plurality of cultivating materials is cut to form a plurality of grooves. The severed end of each of the plurality of cultivating materials is cut to obtain an oblique face. A root-growing agent is applied on the periphery of the lower section and the oblique face of each of the plurality of cultivating materials. The plurality of cultivating materials obtained from the above steps is gathered into a bundle, with the plurality of cultivating materials abutting against each other. The lower sections of the plurality of cultivating materials are planted into earth. A shield is wrapped around an intermediate section of the bundle of the plurality of cultivating materials between the lower section and a top section of the bundle of plurality of cultivating materials. The bundle of plurality of cultivating materials is cultivated for a plurality of months for growing roots from the lower section of each of the plurality of cultivating materials and growing branches and leaves from the top section of each of the plurality of cultivating materials.

The barks of abutting sections between the plurality of cultivating materials can be removed before gathering the plurality of cultivating materials into the bundle.

The top section of each of the plurality of cultivating materials has a length of 1-20 cm not wrapped by the shield. The shield is removed from the bundle of the plurality of cultivating materials after the bundle of the plurality of cultivating materials grows the roots, the branches, and the leaves. The barks of the abutting sections between the plurality of cultivating materials are removed. The shield is rewrapped around the intermediate section of the bundle of the plurality of cultivating materials. The bundle of plurality of cultivating materials is cultivated for a further plurality of months to merge the plurality of cultivating materials. The shield is removed from the intermediate section of the bundle of the plurality of cultivating materials after merge of the plurality of cultivating materials.

The shield can be a plastic film or a plastic tape.

The shield is removed from the intermediate section of the bundle of the plurality of cultivating materials after the bundle of the plurality of cultivating materials grows the roots, the branches, and the leaves.

In an embodiment, planting the lower sections of the plurality of cultivating materials into the earth includes covering the lower sections of the plurality of cultivating materials by wet earth that has a thickness of a plurality of centimeters and that includes at least one root-growing material, wrapping the wet earth with a plastic tape or bag, removing the plastic tape or bag after the wet earth is covered by the plastic tape or bag for one to eight months, and planting the lower sections of the plurality of cultivating materials with or without the wet earth into the earth.

The present invention will become clearer in light of the following detailed description of illustrative embodiments of this invention described in connection with the drawings.

### DESCRIPTION OF THE DRAWINGS

FIG. 1 shows a schematic perspective view illustrating cutting of a length of a bough from a tree according to the present invention.

FIG. 2 shows a schematic perspective view illustrating cutting of a length of a trunk from a tree.

FIG. 3 shows a perspective view illustrating removal of twigs from the length of the bough cut from the tree of FIG. 1.

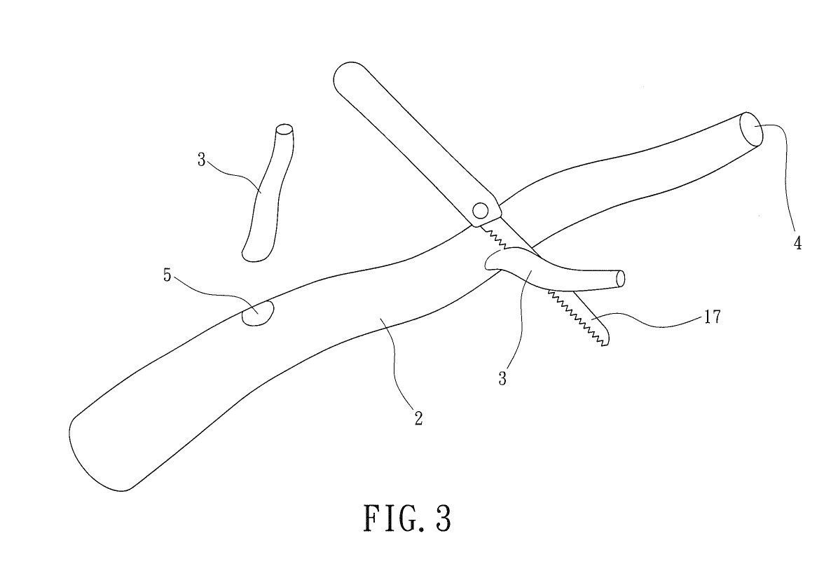

FIG. 4 shows a perspective view illustrating application of a wound healing agent on the length of trunk or bough.

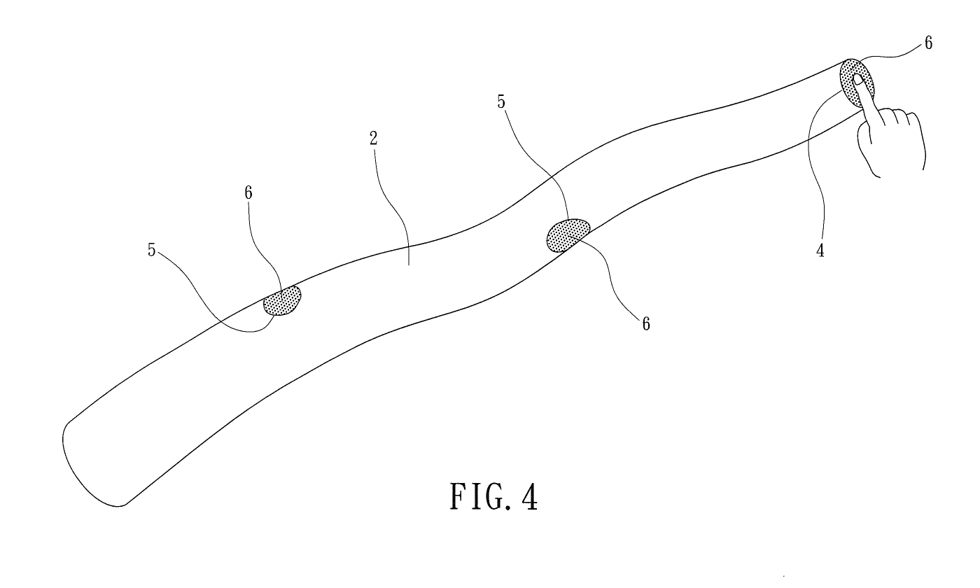

FIG. 5 shows a perspective view similar to FIG. 4, illustrating oblique cutting of the severed end of the length of trunk or bough.

FIG. 6 shows a perspective view similar to FIG. 5, with the length of the trunk or bough cut to form a plurality of grooves.

FIG. 7 shows a perspective view similar to FIG. 6, with a root-growing agent applied to the length of trunk or bough.

FIG. 7A shows a perspective view illustrating another embodiment before planting the length of the trunk or bough into earth.

FIG. 8 shows a perspective view illustrating planting of the length of the trunk or bough of FIG. 7 in earth.

FIG. 9 shows a perspective view similar to FIG. 8, with the length of the trunk or bough wrapped with a shield.

FIG. 10 shows a perspective view illustrating removal of the shield after the length of the trunk or bough of FIG. 9 grows branches and leaves.

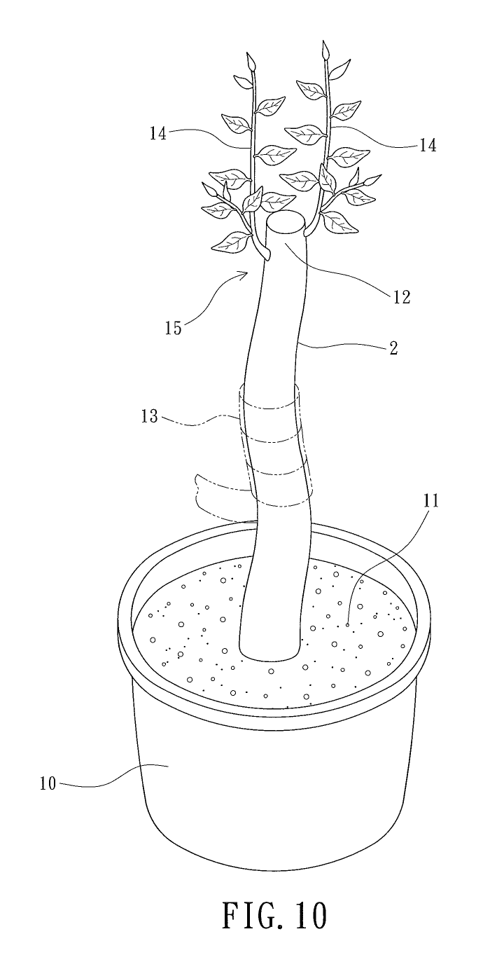

FIG. 11 shows a perspective view illustrating wrapping of a shield on three trunks or boughs.

FIG. 12 shows a perspective view illustrating removal of the shield after the trunks or boughs of FIG. 11 grow branches and leaves.

### DETAILED DESCRIPTION OF THE INVENTION

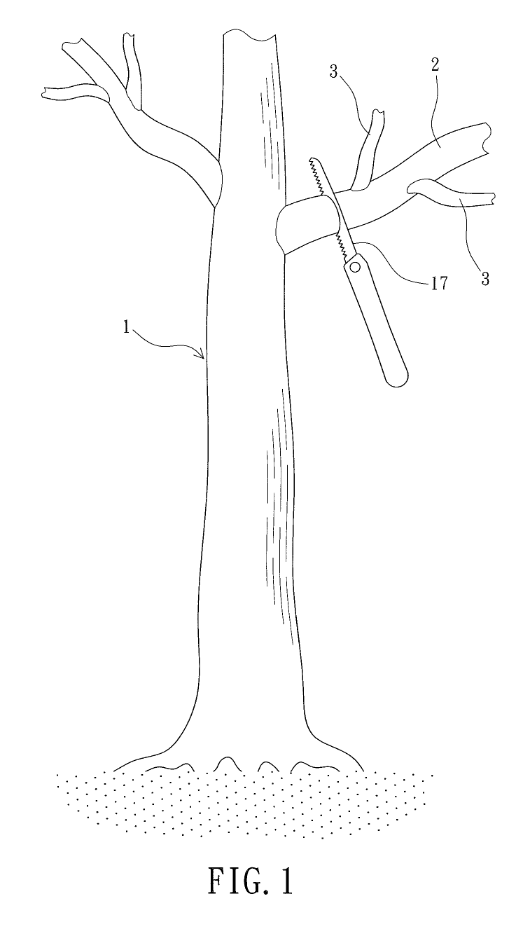

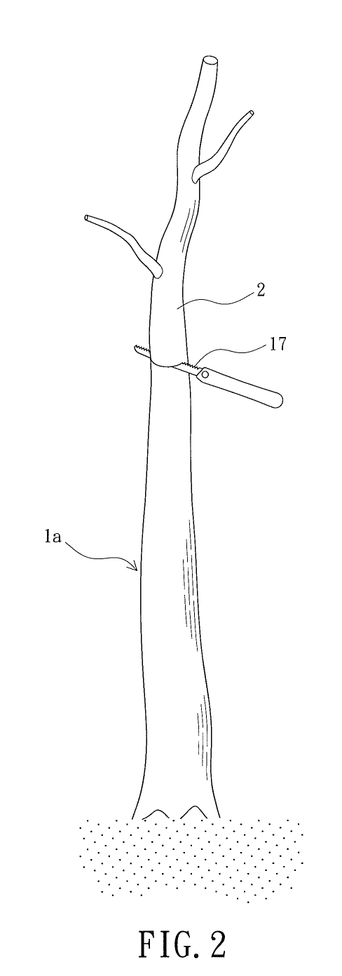

With reference to FIG. 1, a method for rapidly growing a tree according to the present invention can be applied to woody plants such as crape myrtle trees, fringe trees, Chinese banyans, small-leaf elms, autumn maple trees, etc. The method includes obtaining a cultivating material 2 by cutting a length of a bough from a tree 1 (FIG. 1) or a length of a trunk from a tree 1 a (FIG. 2). The length of the cultivating material 2 is in a range between 50 and 350 cm. The diameter of the cultivating material 2 is in a range between 1 and 40 cm. The cultivating material 2 includes a lower section having a severed end that was originally connected to the tree 1, 1a.

Twigs 3 are removed by a tool 17 (such as a saw) from the cultivating material 2. A wound healing agent 6 or while glue is applied on the severed end and on the wounds of the cultivating material 2 resulting from removal of the twigs 3, preventing loss of water and nutrient, healing the wounds, and preventing infection by bacteria.

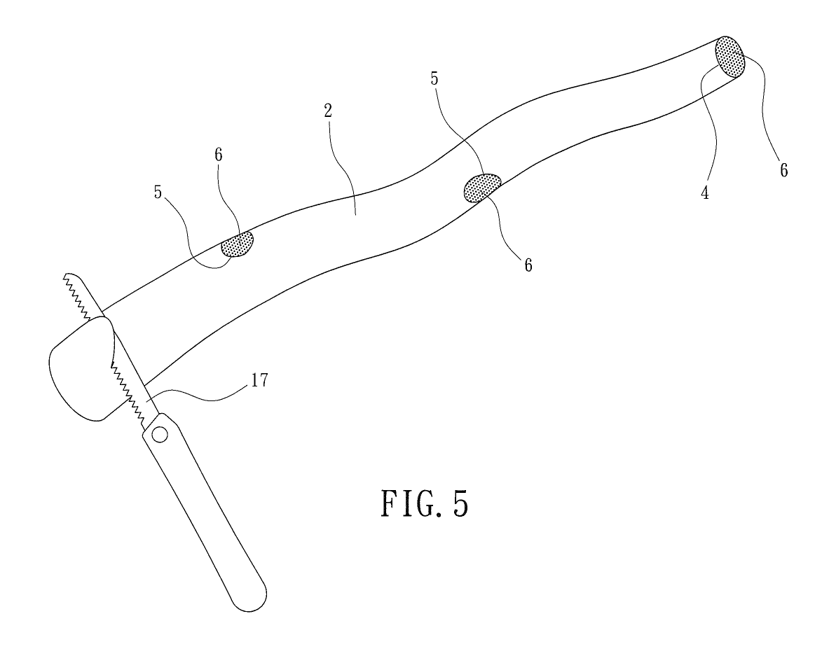

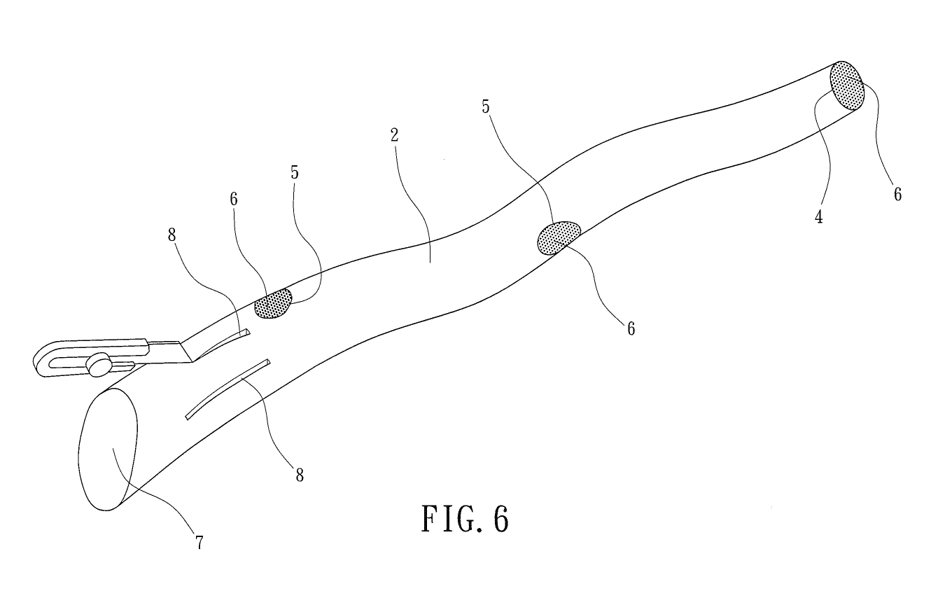

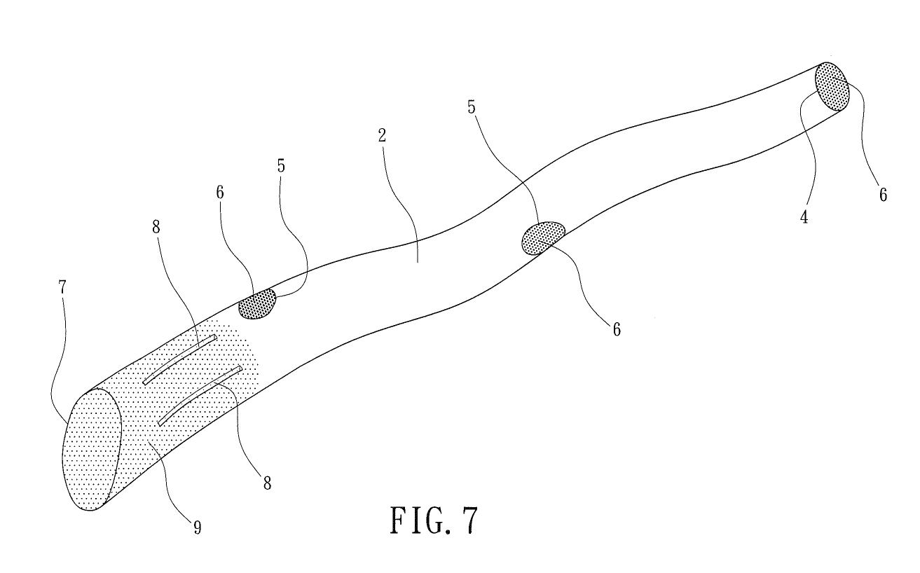

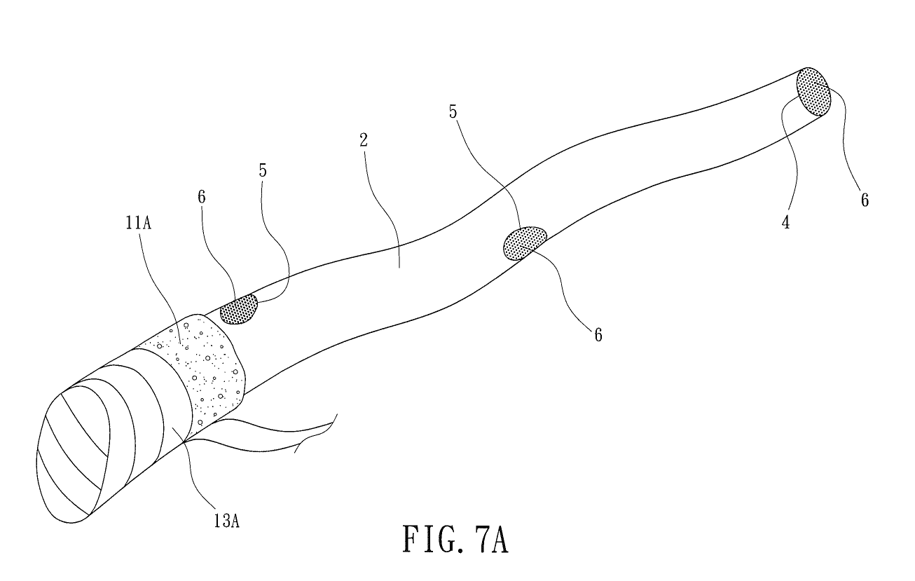

Then, a periphery of the lower section of the cultivating material 2 is cut to form a plurality of grooves 8 (FIG. 6). The severed end of the cultivating material 2 is cut by a tool 17 in an oblique direction to obtain an oblique face 7 (FIG. 5). A root-growing agent 9 is applied on the periphery of the lower section and the oblique face 7 of the cultivating material 2 (FIG. 7). As an example, the oblique face 7 and the lower section of the cultivating material 2 to be inserted into earth are submersed in a root-growing agent having an appropriate concentration or applied with root-growing powders to enhance growth of the roots.

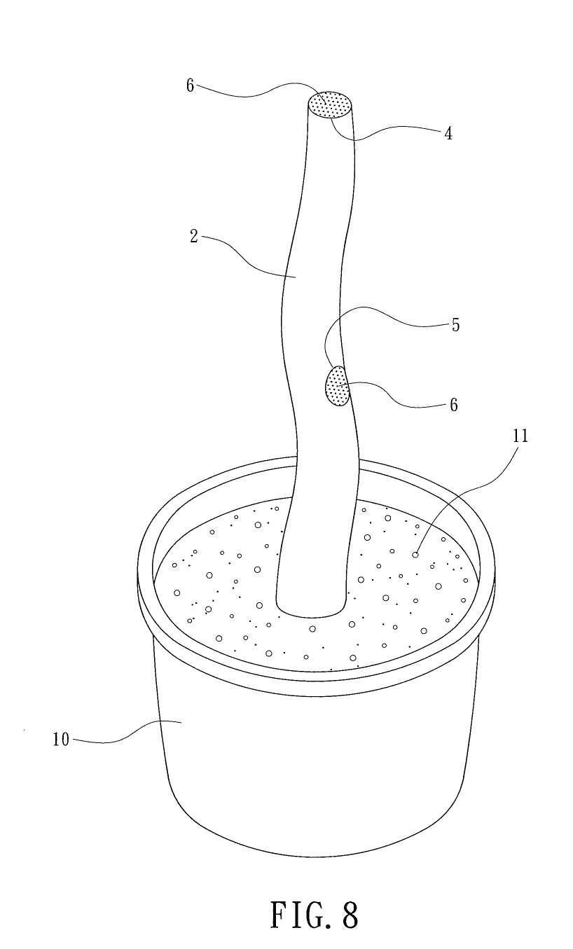

The lower section of the cultivating material 2 obtained from the above steps is planted into earth 11 in a container 10 (FIG. 8).

In an alternate embodiment shown in FIG. 7A, planting the lower section of the cultivating material 2 into the earth 11 includes covering the lower section of the cultivating material 2 by wet earth 11A that has a thickness of a plurality of centimeters and that includes at least one root-growing material, wrapping the wet earth with a plastic tape or bag 13A, removing the plastic tape or bag 13A after the wet earth 11A is covered by the plastic tape or bag 13A for one to eight months, and planting the lower section of the cultivating material 2 with or without the wet earth 11A into the earth 11.

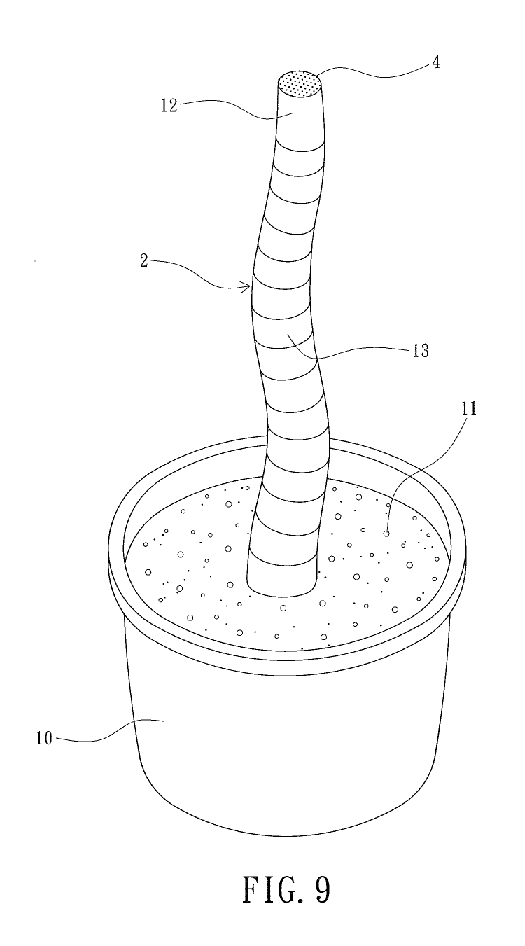

A shield 13 is wrapped around an intermediate section of the cultivating material 2 between the lower section and a top section 12 of the cultivating material 2 (FIG. 9). The shield 13 can be a plastic film or a plastic tape. The top section 12 of the cultivating material 2 has a length of 1-20 cm (having about 1-5 knots) not wrapped by the shield 13 to avoid loss of water and nutrient. The cultivating material 2 is cultivated for a plurality of months for growing roots from the lower section of the cultivating material 2 and growing branches and leaves 14 from the top section of the cultivating material 2. As an example, the cultivating material 2 is placed in a location having proper sunlight and is given a proper amount of water and proper draining. Furthermore, pesticide and bactericide are given to the cultivating material 2. Care including killing termites and applying root-growing agents is given. The cultivating material 2 grows roots from the lower section and grows branches and leaves 14 from the top section 12 of the cultivating material 2 in about 3-12 months.

The shield 13 is removed from the intermediate section of the cultivating material 2 after the cultivating material 2 grows the roots, the branches, and the leaves 14. A decorative tree 15 is, thus, rapidly cultivated.

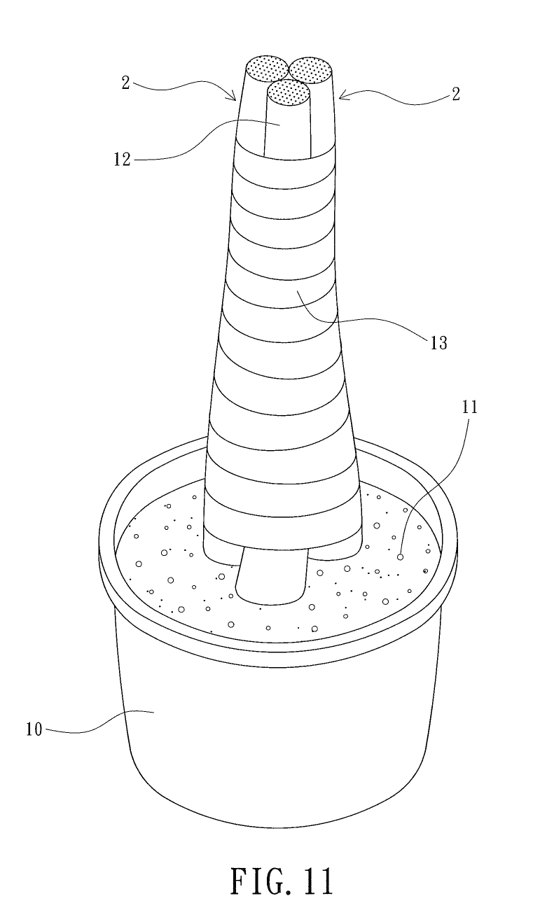

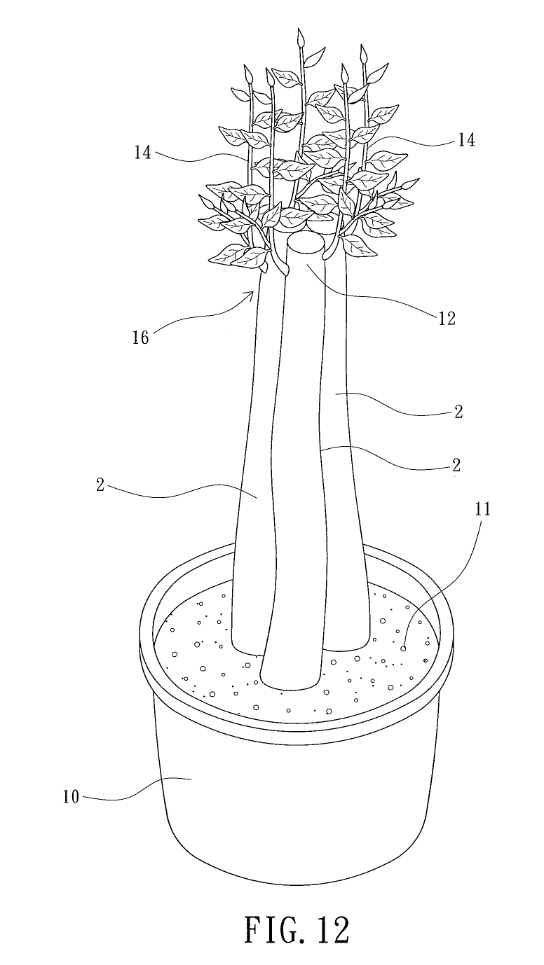

FIGS. 11 and 12 show another example of the method according to the present invention. Specifically, the method includes obtaining a plurality of cultivating materials 2. Each cultivating material 2 is obtained by cutting a length of a trunk or a bough from a tree. Each cultivating material 2 includes a lower section having a severed end that was originally connected to the tree. Twigs are removed from each cultivating material 2. A wound healing agent is applied on the severed end and on wounds of each cultivating material 2 resulting from removal of the twigs. A periphery of the lower section of each cultivating material 2 is cut to form a plurality of grooves. The severed end of each cultivating material 2 is cut in an oblique direction to obtain an oblique face. A root-growing agent is applied on the periphery of the lower section and the oblique face of each cultivating material 2.

The cultivating materials 2 obtained from the above steps are gathered into a bundle, with the cultivating materials abutting against each other. The barks of abutting sections between the cultivating materials can be removed before gathering the cultivating materials into a bundle.

The lower sections of the cultivating materials 2 are planted into earth. A shield 13 is wrapped around an intermediate section of the bundle of cultivating materials 2 between the lower section and a top section of the bundle of cultivating materials 2. The bundle of cultivating materials 2 is cultivated for a plurality of months for growing roots from the lower section of each cultivating materials 2 and growing branches and leaves 24 from the top section 12 of each cultivating material 2. The cultivating materials 2 merge with each other. The shield 13 is removed from the intermediate section of the bundle of cultivating materials 2 after the bundle of cultivating materials 2 grows the roots, the branches, and the leaves 14.

Similar to the first example, the top section 12 of each cultivating material 2 has a length of 1-20 cm not wrapped by the shield 13.

The shield 13 can be removed from the bundle of cultivating materials 2 after the bundle of cultivating materials 2 grows the roots, the branches, and the leaves 14. Furthermore, the barks of abutting sections between the cultivating materials 2 can be removed, and the shield 13 is rewrapped around the intermediate section of the bundle of cultivating materials 2. The bundle of cultivating materials 2 is cultivated for a further plurality of months to merge the cultivating materials 2. The shield 13 is then from the intermediate section of the bundle of cultivating materials 2 after merge of the cultivating materials 2.

Since the cultivating material 2 has a sufficient diameter and a sufficient length, the twigs are removed from the cultivating material 2 to avoid loss of water and nutrient from the cultivating material 2. Thus, the roots can have ample time to grow while avoiding drying and dying of the new grown leaves of the cultivating material 2. The survival rate of the cultivating material 2 is significantly increased while solving the pseudo growth of twig cutting. Furthermore, the boughs or trunks cut from trees are conventionally discarded as wastes. These boughs or trunks can be reused by the methods according to the present invention to reduce contamination of the environment. Further, the land, labor, time, and costs for cultivating trees are significantly reduced. Further, trees can be rapidly cultivated by the methods according to the present invention. The earth can be greened while saving emission of carbon if the methods can be widely used around the globe. The global warming effect and the desertification effect can be reduced. The appearance of the earth can even be changed, which is a great contribution to the earth climate, ecology, and the human living environments.

Although specific embodiments have been illustrated and described, numerous modifications and variations are still possible without departing from the essence of the invention. The scope of the invention is limited by the accompanying claims.

1. A method for rapidly growing a tree comprising:
(a) obtaining a cultivating material by cutting a length of a trunk or a bough from a tree, with the cultivating material including a lower section having a severed end that was originally connected to the tree;
(b) removing twigs from the cultivating material and applying a wound healing agent on the severed end and on wounds of the cultivating material resulting from removal of the twigs;
(c) cutting a periphery of the lower section of the cultivating material to form a plurality of grooves, obliquely cutting the severed end to obtain an oblique face, applying a root-growing agent on the periphery of the lower section and the oblique face of the cultivating material; and
(d) planting the lower section of the cultivating material obtained from steps (a), (b), and (c) into earth, wrapping a shield around an intermediate section of the cultivating material between the lower section and a top section of the cultivating material, and cultivating the cultivating material for a plurality of months for growing roots from the lower section of the cultivating material and growing branches and leaves from the top section of the cultivating material.

2. The method as claimed in claim 1, with the top section of the cultivating material having a length of 1-20 cm not wrapped by the shield.

3. The method as claimed in claim 1, with wrapping the shield including wrapping a plastic film or a plastic tape around the intermediate section of the cultivating material.

4. The method as claimed in claim 1, further comprising: removing the shield from the intermediate section of the cultivating material after the cultivating material grows the roots, the branches, and the leaves.

5. The method as claimed in claim 1, with planting the lower section of the cultivating material into the earth including:
covering the lower section of the cultivating material by wet earth that has a thickness of a plurality of centimeters and that includes at least one root-growing material;
wrapping the wet earth with a plastic tape or bag;
removing the plastic tape or bag after the wet earth is covered by the plastic tape or bag for one to eight months; and
planting the lower section of the cultivating material with or without the wet earth into the earth.

6. A method for rapidly growing a tree comprising:
(a) obtaining a plurality of cultivating materials, with each of the plurality of cultivating materials obtained by cutting a length of a trunk or a bough from a tree, with each of the plurality of cultivating materials including a lower section having a severed end that was originally connected to the tree;
(b) removing twigs from each of the plurality of cultivating materials and applying a wound healing agent on the severed end and on wounds of each of the plurality of cultivating materials resulting from removal of the twigs;
(c) cutting a periphery of the lower section of each of the plurality of cultivating materials to form a plurality of grooves, obliquely cutting the severed end of each of the plurality of cultivating materials to obtain an oblique face, applying a root-growing agent on the periphery of the lower section and the oblique face of each of the plurality of cultivating materials; and
(d) gathering the plurality of cultivating materials obtained from steps (a), (b), and (c) into a bundle, with the plurality of cultivating materials abutting against each other, planting the lower sections of the plurality of cultivating materials into earth, wrapping a shield around an intermediate section of the bundle of the plurality of cultivating materials between the lower section and a top section of the bundle of plurality of cultivating materials, and cultivating the bundle of plurality of cultivating materials for a plurality of months for growing roots from the lower section of each of the plurality of cultivating materials and growing branches and leaves from the top section of each of the plurality of cultivating materials.

7. The method as claimed in claim 6, further comprising: removing barks of abutting sections between the plurality of cultivating materials before gathering the plurality of cultivating materials into the bundle.

8. The method as claimed in claim 6, with the top section of each of the plurality of cultivating materials having a length of 1-20 cm not wrapped by the shield, with the method further comprising: removing the shield from the bundle of the plurality of cultivating materials after the bundle of the plurality of cultivating materials grows the roots, the branches, and the leaves; removing barks of abutting sections between the plurality of cultivating materials; rewrapping the shield around the intermediate section of the bundle of the plurality of cultivating materials; and cultivating the bundle of plurality of cultivating materials for a further plurality of months to merge the plurality of cultivating materials.

9. The method as claimed in claim 8, further comprising: removing the shield from the intermediate section of the bundle of the plurality of cultivating materials after merge of the plurality of cultivating materials.

10. The method as claimed in claim 6, with wrapping the shield including wrapping a plastic film or a plastic tape around the intermediate section of the bundle of the plurality of cultivating materials.

11. The method as claimed in claim 6, further comprising: removing the shield from the intermediate section of the bundle of the plurality of cultivating materials after the bundle of the plurality of cultivating materials grows the roots, the branches, and the leaves.

12. The method as claimed in claim 6, with planting the lower sections of the plurality of cultivating materials into the earth including:
covering the lower sections of the plurality of cultivating materials by wet earth that has a thickness of a plurality of centimeters and that includes at least one root-growing material;
wrapping the wet earth with a plastic tape or bag;
removing the plastic tape or bag after the wet earth is covered by the plastic tape or bag for one to eight months; and
planting the lower sections of the plurality of cultivating materials with or without the wet earth into the earth.
